(19) United States
(12) Patent Application Publication
(10) Pub. No.: US 2006/0246256 A1
(43) Pub. Date: Nov. 2, 2006

(54) Elevated structured loop

(75) Inventors: Ronald W. Ausen, St. Paul, MN (US); Jayshree Seth, Woodbury, MN (US); Janet A. Venne, Roseville, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/116,555

(22) Filed: Apr. 28, 2005

(51) Int. Cl. B32B 3/06

(52) U.S. Cl. 428/100; 428/99

(57) ABSTRACT

There is provided a loop laminate for use in a hook and loop fastening system or a hook and loop fastening system. The loop laminate first comprises a backing layer, having a first face and a second face. The backing layer has a plurality of elevated projections extending from at least the first face of the backing layer wherein some of the projections extend by a distance of at least 50 μm. A loop material is attached to at least some of the projections such that said loop material is raised off the backing layer over at least some portion of the distance between adjacent attached projections to allow for hook heads of hooks to easily penetrate the loop material. The hook fastening material has hooks that are arranged in a manner so as to not substantially engage the projections when the hook fastener is engaged with the loop laminate

### BACKGROUND AND SUMMARY

The present invention relates to a loop laminate for a hook and loop fastener having at least one sheet of flexible loop material intermittently bonded to a structured backing. The invention further relates to methods for producing these loops.

Loops formed by lamination of nonwovens to film are known from, for example, U.S. Pat. No. 5,032,122 which are formed by providing a backing of orientable material in its dimensionally unstable state; positioning a plurality of filaments on the backing; securing the filaments to the backing at spaced, fixed regions along each of the filaments, the fixed regions defining between each pair of fixed regions, an unsecured catching region; and causing the orientable material to be transformed along its path of response to its dimensionally stable state thereby shirring the filaments at the catching regions to form fibrous elements projecting from the backing between the fixed regions.

U.S. Pat. No. 5,547,531 describes forming a loop by a method comprising the steps of providing a first lamina comprising an elastomeric, pressure-sensitive adhesive film having a first adhesive surface and a second adhesive surface opposed to said first adhesive surface; a relaxed orientation and an elongated orientation; stretching said first lamina from said relaxed orientation to said elongated orientation; contacting a second lamina comprising a nonwoven web with said first surface of said first lamina in said elongated orientation, thereby directly joining said second lamina and said first lamina to form a laminate; and relaxing said first lamina such that said second lamina is shirred to form catching regions capable of entangling the hooks of a complementary male fastening component.

U.S. Pat. No. 5,595,567 also uses a nonwoven web, which is preferably joined with a backing while the backing is in its elongated unstable orientation. Construction bonds form a bond pattern joining the nonwoven web to the backing. When the backing is contracted from its elongated orientation to its relaxed orientation, the unsecured regions of the nonwoven web become shirred and extend outwardly from the backing to form catching regions that are capable of entangling the engaging elements of a complementary male fastening component.

U.S. Pat. No. 5,256,231 describes a method of providing a sheet of loop material adapted to be cut into pieces to form loop portions for fasteners of the type comprising releaseably engageable hook and loop portions and incorporated into items such as disposable garments or diapers. The sheet of loop material includes a sheet of longitudinally oriented fibers having anchor portions and arcuate portions projecting in one direction away from the anchor portions, and a layer of thermoplastic backing material extruded onto the anchor portions to bond to the anchor portions forming at least a portion of a backing for the loop material.

All these methods of forming loops stress the importance of the loop fibers to project outwardly from a backing or base layer. This increases the availability of the fibers to engage suitable hook elements. However, the backings are generally specialized and costly, dimensionally unstable, or thick. It is desired to provide a loop material that is lower cost and easier to manufacture.

### BRIEF DESCRIPTION OF THE INVENTION

The invention is directed at a loop laminate for use in a hook and loop fastening system. The loop laminate comprises a backing layer, having a first face and a second face. The backing layer has a plurality of elevated projections extending from at least the first face of the backing layer wherein some of the projections extend by a distance of at least 50 μm. A loop material is attached to at least some of the projections forming the laminate such that said loop material is raised off the backing layer over at least some portion of the distance between adjacent attached projections. This then allows for hook heads of hooks to easily penetrate the loop material between the attached projections.

The invention is also directed at a hook and loop fastening system. The loop laminate comprises a backing layer, having a first face and a second face. The backing layer has a plurality of elevated projections extending from at least the first face of the backing layer wherein some of the projections extend by a distance of at least 50 μm. A loop material is attached to at least some of the projections forming the laminate such that said loop material is raised off the backing layer over at least some portion of the distance between adjacent attached projections. The hook fastener is provided with a plurality of hook heads, which hook heads are distributed in a manner such that they are capable of engaging the loop material in the regions between the attached projections and minimally contacting the projections.

### BRIEF DESCRIPTION OF THE DRAWINGS

The present invention is further described in reference to the accompanying drawings, where like reference numerals refer to like parts on several views, and wherein:

FIG. 1(a) is a schematic view illustrating a method of forming the loop material of the invention such as depicted in FIGS. 2(a) and 2(b).

FIG. 1(b) is a schematic view illustrating a second method of forming the loop material of the invention.

FIG. 1(c) is a front view of a die insert used to produce a structured film backing useable in forming a loop material.

FIG. 2(a) is a perspective view of a first embodiment of loop material prepared according to the present invention.

FIG. 2(b) is a side view photograph of a first embodiment loop material prepared according to the present invention.

FIG. 3 is a perspective view of a second embodiment backing usable in forming a loop material of the present invention.

FIG. 4 is a perspective view of a third embodiment backing usable in forming a loop material of the present invention.

FIG. 5 is a perspective view of a fourth embodiment backing usable in forming a loop material of the present invention.

FIG. 6a is a side view photograph of a hook material engaged with a loop material of the present invention.

FIG. 6b is a schematic side view of a hook material engaged with a loop material of the present invention.

FIG. 6c is an enlarged schematic side view of a hook material engaged with a loop material of the present invention.

FIG. 7 is a schematic side view of a fifth embodiment backing usable in forming a loop material of the present invention.

FIG. 8 is a schematic side view of FIG. 7 backing joined to a loop fabric.

FIG. 9 is a schematic side view of a sixth embodiment backing usable in forming a loop material of the present invention.

### DETAILED DESCRIPTION

The invention loop laminate may be formed by providing a backing having a plurality of upstanding projections, then anchoring a web of flexible loop material onto upper portions of at least some of the projections.

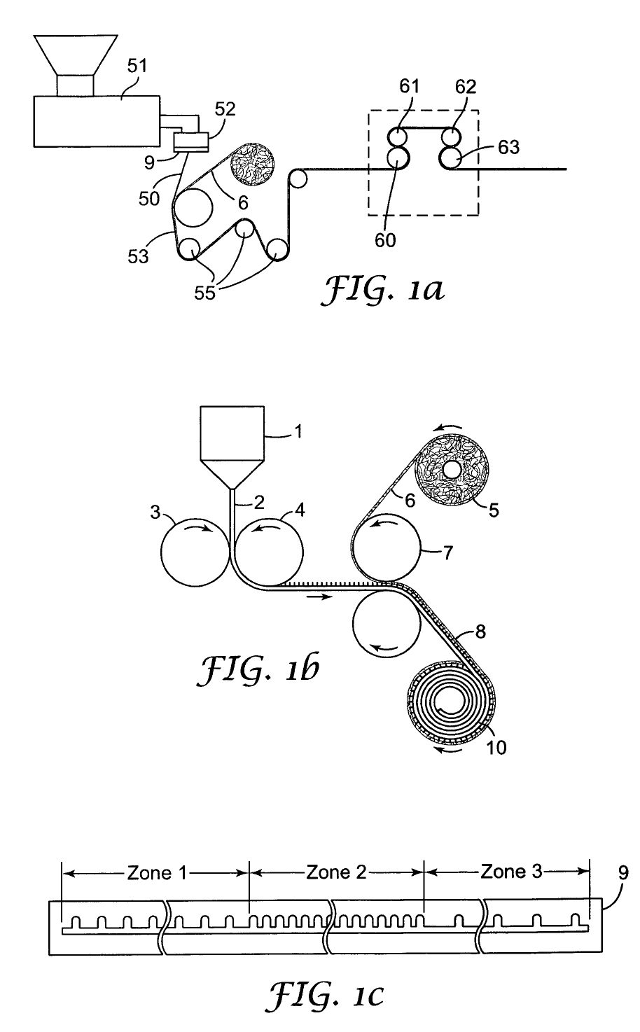

The loop laminate can be made by a method such as shown in FIG. 1(a). An extrusion die 52, extrudes a thermoplastic material forming a film backing having an array of upstanding projections. These projections could be formed at the die lip 9 directly forming a structured film 50 with extending projections. This generally would be a film having a series of continuous ridges, however pulsing dies could form discontinuous ridges. Alternatively, the polymer exiting the die could have projections formed on a molding tool surface 4, such as disclosed in U.S. Patent Publication 2003/111767 A1, where the moldable material 2 is applied to the tool surface 4 by extrusion or molding to create a film with projections that are replicates of cavities in the tool surface 4, as generally depicted in FIG. 1(b).

The backing layer is then joined to a loop material 6, which can be supplied from a supply form, such as a roll or could be made inline with the backing 50. The loop material 6 is bonded to the backing 50, which bonding can be done with heat, ultrasonics, adhesives, extrusion lamination, mechanical entanglement, or the like, or combinations of these methods. The loop material 6 is laminated to form the loop laminate 8, 53 and is collected in a suitable form such as on a roll 10. Optionally, the loop laminate can be length oriented using an arrangement as shown in FIG. 1A. A pair of nip rollers 60, 61 and 62, 63 are driven at different speeds with nip rollers 62, 63 being driven at the higher rate of speed to stretch the loop laminate. Further, the loop laminate could also be stretched in the transverse direction to provide a biaxially oriented loop laminate.

The backing layer is generally a continuous backing having an array of upstanding projections that support the loop material. The backing is generally a film backing with integrally formed projections. However, projections could be formed on a preformed backing by extrusion coating (such as described in WO 03/039834), printing, lamination or the like, in this case the backing could be a film, a fibrous material, such as a woven backing or consolidated nonwoven, or netting or the like. Integrally formed projections on a backing, however are superior in that the only requirement is that the backing be generally dimensionally stable for providing a dimensionally stable loop laminate such as an inelastic backing. However, dimensionally unstable backings such as an elastic film backing could be used if desired.

The projections used on the backing layers of the preferred embodiments generally are structures where the heights of the projections supporting the loop material are generally from 50 μm to 1000 μm in height (h), or from 100 μm to 500 μm in height (h). The projections can generally all be of equal height. This allows the loop to be uniformly supported and have generally uniform performance properties. However it is possible that the projections vary in height to create zones that support the loop at varying elevations to provide tailored performance. Alternatively, projections of lower height could be used between higher elevation projections to, for example, support the loop that may sag between the primary supporting projections. Although the projections can have different heights, at least a portion of the projections are generally in the range of from 50 μm to 1000 μm in height or from 100 μm to 500 μm in height. The projections height (h) should generally be higher than the height of the hook head 48 that is intended to be used with the loop laminate, generally at least 10 percent higher or 50 percent higher, however the hook head height 48 could be greater than the projection height (h) if the loop material loft allows engagability (e.g. the height of the projection plus the overlying loop is greater than the hook head height). The projections could also be characterized by their profile where the ratio of the height (h) to the smallest diameter or width (w) is greater than 0.1, preferably greater than 0.5 theoretically up to infinity. However if the height of the projections is greater than 2000 microns the film can become difficult to handle and it is preferable that the height of the structures is less than 1000 microns.

Generally, the projections can extend over all or just a region of the backing. The projections, where they are provided on the backing to support a loop, generally can occupy at least 0.5 percent of the backing surface area based on the area occupied by the peaks of the projections. The projection's peaks could occupy at least 2 percent of the backing layer up to about 30 percent, or up to about 10 percent. The projections may taper away from the backing and the base of the projections could occupy a much greater surface area of the backing than the peaks or tips. Generally the projections need to provide continuous support for the loop. As such, the projections are sufficiently closely spaced so that the loop does not sag onto the backing layer excessively. Generally the loop material between adjacent projections will be raised off the backing over at least 10 percent of the distance between adjacent supporting projections, or from 30 to 100 percent or 50 to 100 percent. The projections need to provide sufficient unsupported loop at an elevation such that hook heads can penetrate the loop in the unsupported areas to create an effective closure. If the projections are too numerous or too large in cross section at the peaks, less of the loop is available for effective bonding with matching hooks. The projection peaks generally can have a width (w) of from 50 to 1000 μm or from 100 to 500 μm.

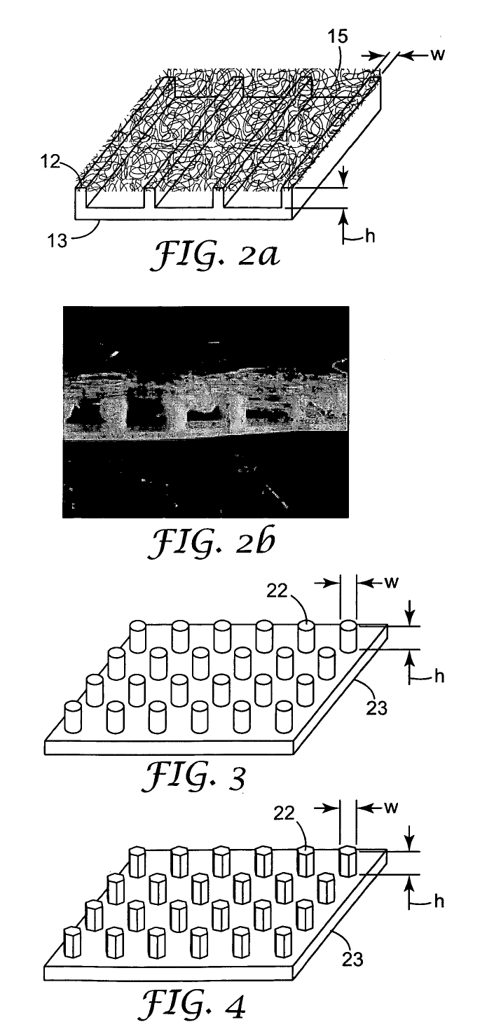

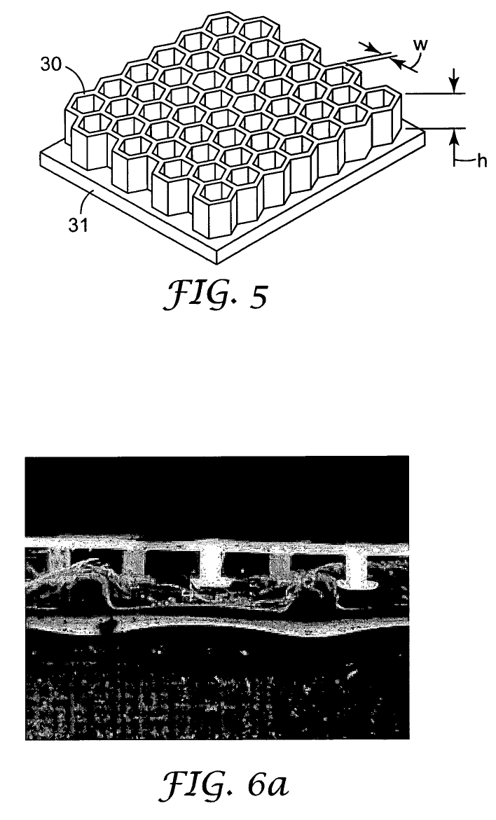

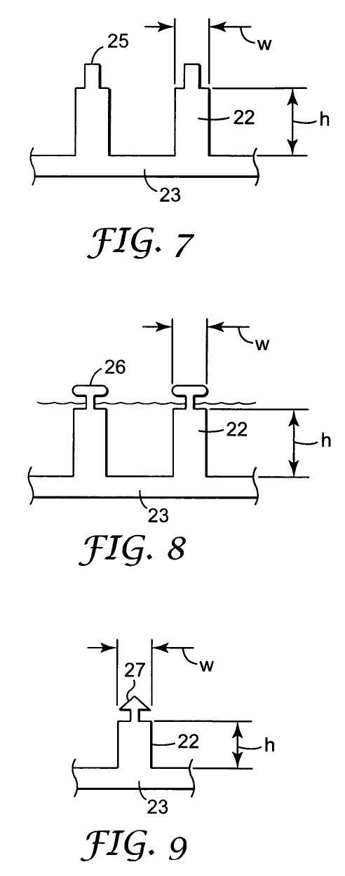

The projections can be any suitable shape that will allow them to support a loop and provide unsupported loop available at a level that allows for hook head penetration without substantial interference from the projections. The projections, for example, can be discrete posts or ridges, which ridges could be continuous or discrete. Discrete post projections 22 on a backing 23, as shown in FIGS. 3 and 4, could be in the shape of upstanding stems, pyramids, cube corners, J-hooks, mushroom heads, or the like. Ridges could be continuous or intermittent ridges and could be rectangular or v-shaped ridges with intervening channels, closed cell ridges with enclosed open areas or combinations thereof. These ridges can be regular or random and be combined with other structures such as post-like projections. These ridges could extend in lines or curves or at random angles. The ridge type structures could extend parallel to one another, or be at intersecting or nonintersecting angles and be combined with other structures between the ridges, such as nested ridges or post-type projections. The ridges when joined back on themselves can form closed cell ridges 30 on a backing 31, and the like as shown in the embodiment of FIG. 5. In one embodiment, the ridges 12 could extend continuously over at least one dimension of the backing 13, and support the fibrous loop material 15, as shown in FIGS. 2(a) and 2(b). The projections could also be provided with smaller projections at their peaks to mechanically engage with a loop. These projections could be hook-like projections 27 as shown in FIG. 9. Alternatively, the projection could be just a post that can penetrate the loop material as shown by the post-type projection 25 of FIG. 7. Either of these projections could be subjected to heat and pressure to create a cap or the like 26 to mechanically engage the loop material as shown in FIG. 8. The cap 26 could also fuse with the fibers forming the loop material

The projections can be made by any known method, such as the methods disclosed in U.S. Pat. Nos. 5,069,404 and 5,133,516, both to Marantic et al.; U.S. Pat. No. 5,691,846 to Benson et al.; U.S. Pat. No. 5,514,120 to Johnston et al.; U.S. Pat. No. 5,158,030 to Noreen et al.; U.S. Pat. No. 5,175,030 to Lu et al.; U.S. Pat. No. 4,668,558 to Barber; U.S. Pat. No. 4,775,310 to Fisher; U.S. Pat. No. 3,594,863 to Erb; U.S. Pat. No. 5,077,870 to Melbye et al or U.S. Patent Application 2003/0085485 to Siedel et al., and U.S. Pat. Nos. 6,767,202 and 6,190,594, both to Gorman. These methods are all incorporated by reference in their entirety.

Polymers useful in forming a structured backing layer or projections used on a backing layer in the present invention include but are not limited to polyolefins such as polyethylene and polyethylene copolymers, polypropylene and polypropylene copolymers. Other polymeric materials include polyesters, polyamides, poly(vinyl chloride), polyurethanes, and polystyrene. Structured film backing layers can also be cast from curable resin materials such as acrylates or epoxies and cured through free radical pathways promoted chemically, by exposure to heat, UV, or electron beam radiation. The backing could also be a consolidated nonwoven, paper, knit materials, woven materials, or other film-like material such as disclosed in U.S. Patent Application 2003/085485 to Siedel et al.

Fibers suitable for forming a fibrous loop can be produced from a wide variety of thermoplastic polymers that are known to form fibers. Suitable thermoplastic fiber forming polymers are selected from polyolefins, polyamides, polyesters, copolymers containing acrylic monomers, and blends and copolymers thereof. Suitable polyolefins include polyethylene, e.g., linear low density polyethylene, high density polyethylene, low density polyethylene and medium density polyethylene; polypropylene, e.g., isotactic polypropylene, syndiotactic polypropylene, blends thereof and blends of isotactic polypropylene and atactic polypropylene; and polybutylene, e.g., poly(1-butene) and poly(2-butene); polypentene, e.g., poly-4-methylpentene-1 and poly(2-pentene); as well as blends and copolymers thereof. Suitable polyamides include nylon 6, nylon 6/6, nylon 10, nylon 4/6, nylon 10/10, nylon 12, nylon 6/12, nylon 12/12, and hydrophilic polyamide copolymers such as copolymers of caprolactam and an alkylene oxide, e.g., ethylene oxide, and copolymers of hexamethylene adipamide and an alkylene oxide, as well as blends and copolymers thereof. Suitable polyesters include polyethylene terephthalate, polybutylene terephthalate, polycyclohexylenedimethylene terephthalate, and blends and copolymers thereof. Acrylic copolymers include ethylene acrylic acid, ethylene methacrylic acid, ethylene methylacrylate, ethylene ethylacrylate, ethylene butylacrylate and blends thereof. The projections are, in a preferred embodiment, formed from a polymer that is compatible with at least some of the fibers forming a loop material such that they are capable of autogenously bonding.

Fibers can be formed into a nonwoven fibrous loop by any suitable method such as carding, hydroentanging, and needlepunching. Alternatively, the nonwoven fibrous loop web can be directly formed from thermoplastic fiber forming polymers such as by melt spinning or melt blowing and like techniques that directly form nonwovens from a polymer melt. Fibers can also be formed into suitable loop materials by knitting, weaving or forming nettings. The loop could also be formed of discrete non-entangled fibers such as continuous substantially parallel filaments or yarns. Generally, a nonwoven fibrous loop web will have a basis weight of from 10 to 100 g/m², preferably 10 to 50 g/m² and in some embodiments, comprise at least in part, thermoplastic fibers suitable for autogenously bonding. Generally at least 10 percent of the fibers are of the bondable thermoplastic type, and in specific embodiments are from 20 to 100 percent bondable thermoplastic fibers. The majority of the individual fibers forming the fibrous web are preferably on average 1 to 70 μm in diameter. The backing layer generally has a basis weight of from 15 to 150 g/m², preferably from 20 to 50 g/m². If a nonwoven is used, the total nonwoven loop laminate in a preferred embodiment has a basis weight of from 30 to 300 g/m², preferably 40 to 100 g/m².

Preferably, the loop web should have a relatively low basis weight so that there will be adequate space between the fibers of the loop web for the hook heads of a mating hook fastener to penetrate between open areas of the fibers.

The loop web is preferably comprised of relatively long fibers. The longer the fibers, the easier it is to bond these fibers to each other and to the backing layer projections. If extremely short fibers are used, there may be an excessive number of unbonded loose fibers or partially bonded fibers (e.g., fibers with only one of their ends bonded). Such fibers will be incapable of entangling and holding the hook heads of the hook fastener. The lengths of the fibers in a nonwoven web depend upon the type of process used to make the nonwoven loop web. For instance, if a carded nonwoven web is used, the fibers that comprise such a web can have lengths that can range from about 0.5 inch to about 5 inches (from about 1 cm. to about 13 cm.). Preferably, the fibers are between about 2 inches and about 3 inches (between about 5 cm. and about 8 cm.) long. If, on the other hand, a spunbonded nonwoven web is used, the fibers or filaments of such a web will typically be continuous in length.

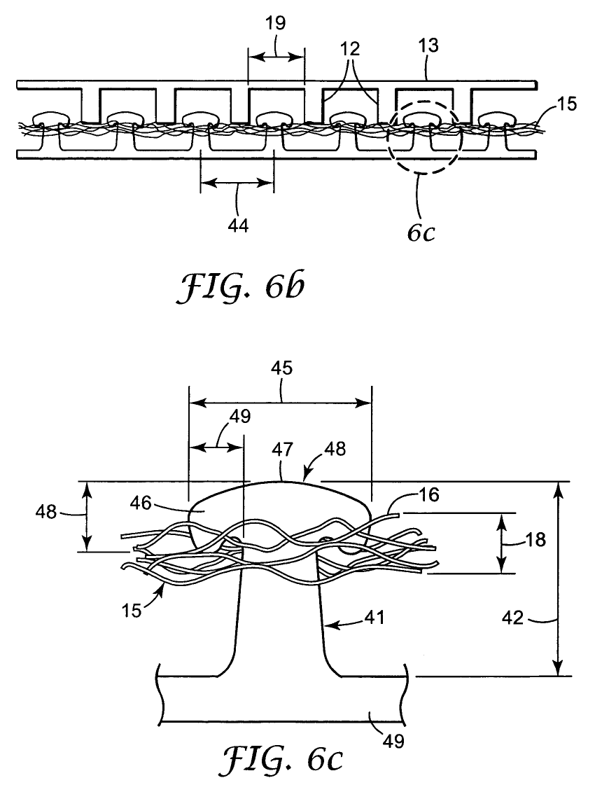

The diameter of the fibers is one factor that determines the strength of a loop web and the engageability with suitable hook heads. A common measure of diameter is known as denier. (Denier is a unit of fineness of a yarn weighing one gram for each 9,000 meters, thus a 100-denier yarn is finer than a 150-denier yarn.) Generally, the larger the diameter of the fiber, the stronger the fiber, but the larger the hook head overhang 49 needed to engage the fiber. The maximum fiber diameter that can be used depends in part on the size of the opening between the fibers and the fiber engaging overhang (49) of the hook heads (46) as shown in FIG. 6c. The diameter of the fibers must not be so great that the hook heads are unable to grab and entangle the fibers. Typically, for currently available hook components, the fibers of a nonwoven loop web should have a denier of between about 2 and about 15. Hooks that are substantially smaller could be used with smaller denier fibers such as between about 0.5 and about 15, or less. It is possible that fibers having deniers as low as between about 0.5 and about 1.0, or less, could be used with smaller hook heads. Such fibers may be referred to as “micro denier” fibers.

The amount of inter-fiber bonding between the fibers of the nonwoven loop web determines in part the amount of open area between the fibers available for hook head penetration as well as the nonwoven loop web integrity. The bond sites created by the bonds between the fibers, either internal fiber-to-fiber bonds or point bonds of the web as a whole, will tend to reduce the degree of freedom for the fibers to spread so as to accommodate the hook heads. But increased bond sites will increase web integrity and reduce the number of loose fibers. The degree of inter-fiber bonding depends on the type of nonwoven material used to form the loop and the degree of point bonding used to increase the web integrity. The nonwoven loop web could be initially unbonded and then later point bonded during the process of manufacturing the loop laminate, either prior to bonding to the projections or by the bond sites with the projections. The degree of bonding is generally selected to allow the web and/or loop laminate to be of sufficient integrity to be handled in the manufacturing process as well as to provide integrity to the web. The hook heads must engage with individual fibers, that are bonded or entangled at, at least two points so that the hook must not easily pull the engaged fiber out during disengagement of the hook fastener, whether the loop is a nonwoven or any other type of loop. Generally with nonwoven loops, the inter-fiber bonds should occupy less than about 10%, preferably less than about 6%, and most preferably less than about 2.5% of the area of the nonwoven loop web. This will assure that the space occupied by the inter-fiber bonds will not interfere with the penetration of the hook heads of the mating hook fastener. If the nonwoven fibrous web material is provided by carding, Rando webs, airlaid webs, spunlace webs, spunbond webs, or the like, the nonwoven fibrous material is preferably not prebonded or consolidated to maximize the open area between the fibers. However, in order to allow preformed webs to be handled, it is necessary on occasion to provide suitable point bonding and the like which should be at a level only sufficient to provide integrity to unwind the preformed web from a roll and into the forming process for creating the invention nonwoven loop composite.

Generally, the portion of the nonwoven loop web that is unbonded to the backing projections, is from 99.5 to 50 percent of the surface area of the backing, providing bonded areas of from 50 to 0.5 percent of the surface area of the nonwoven loop web, preferably, the overall bonded area of the nonwoven loop web is from 20 to 2 percent. The bonded areas include those areas of the sheet of fibers bonded to the backing layer projections as well as any prebonded or consolidated areas provided to improve web integrity. The specific bonding portions or areas bonded to the projections of the backing layer generally can be any width; however, preferably are from 0.01 to 0.2 centimeters in its narrowest width dimension. Adjacent bonding projections are generally on average spaced from 50 μm to 1000 μm, and preferably 50 μm to 500 μm apart.

In order to maintain the desirable softness of the loop laminate, a film-like backing layer or layers generally has a thickness apart from the projections of from 10 to 300 microns, preferably from 20 to 100 microns providing a soft fibrous loop laminate. The loop laminate has sufficient tensile strength in order to be reliably used in continuous manufacturing techniques requiring a dimensionally stable material, generally having a tensile strength of at least 0.5 kg/cm, preferably at least 1.0 kg/cm.

The term “hook” as used herein, is used to designate the engaging elements of the hook fastener. The term “hook” is non-limiting in the sense that the engaging elements may be in any shape known in the art so long as they are adapted to engage a complementary loop material. The hook fastener comprises a base layer having a first surface and a second surface and a plurality of hooks extending from at least the first surface of the base. Each of the hooks preferably comprises a stem supported at one end on the base and an enlarged head positioned at the end of the stem opposite the base. The hook fasteners used with the loop laminate of the present invention can be conventional, commercially available hook materials.

The hook fastener can have hooks with blunt or mushroom heads or more pointed heads. As shown in FIGS. 6b and 6c the apex 47 of the hook head 46 will first come in contact with the invention loop laminate when the loop laminate and the complementary hook fastener are placed in face-to-face relationship with each other as shown in FIG. 6b. The hook head height 48 allows the hook head to penetrate the loop material 15, allowing the hook head overhang 49 to engage with individual fibers 16 of the loop material 15. The thickness 18 of the loop material 15, as seen in FIG. 6c does not need to be greater than the hook head height 48 for the hook head overhang 49 to engage with individual fibers 16. However, for the hooks to engage properly, the hook head should be free to engage the loop material 15, where the loop material 15 is not supported by projections 12. The hook heads as such when pressed against the loop laminate should have a substantially noninterfering spacing and distribution relative to the projections 12. This can be accomplished by first keeping the hook head width 45 less that the spacing 19 between adjacent projections 12. Preferably the hook head width 45 is at least 30 percent less than the spacing 19 or 50 percent less or more. Secondly, the periodicity of the hook heads should be such that there is minimal interference with the projections 12. Generally the interference is less than 30 percent (less than 30 percent of the hooks will contact projections when laid on top of each other in the least interfering manner), with 10 percent or less being better. This can be accomplished by having the hooks being spaced apart by substantially the same distance 44 as the spacing 19, or some multiple of the spacing 19 (e.g. distance 44 is equal to a constant X times spacing 19, where X is an whole number or close to a whole number, such as plus or minus 5 percent or less of a whole number).

Generally the hook head has a blunt head with a generally rounded, flat, or any other shape that does not provide a sharp point, such as described in U.S. Pat. Nos. 5,077,870 and 4,894,060. The hooks are generally of uniform height, preferably from about 0.10 to 1.3 mm in height, and more preferably from about 0.2 to 0.5 mm in height. The hooks could be J shaped or have a rounded, oval, T or other shaped head and may have overhangs extending out in multiple directions from a stem. Capping the top of a hook or stem to provide a hook having a smooth or rounded upper surface is one preferred embodiment of forming a hook strip as disclosed for example in U.S. Pat. Nos. 5,077,870, 6,558,602, 6,635,212, and 6,000,106, the substance of which are incorporated by reference in their entirety. The hooks could have a density on a hook backing preferably of from 20 to 1,600 hooks per square centimeter, and more preferably from about 40 to 150 hooks per square centimeter. With capped hooks, the stem portions have a diameter adjacent the heads of the capped stem hooks, preferably from 0.07 to 0.7 mm, and more preferably from about 0.1 to 0.3 mm. The capped heads project radially past the stem portions on at least one side to provide a hook head overhang preferably by, on average, about 0.01 to 0.3 mm, and more preferably by, on average, about 0.02 to 0.25 mm and have average thicknesses between their outer and inner surfaces (i.e., measured in a direction parallel to the axis of the stems) preferably from about 0.01 to 0.3 mm and more preferably from about 0.02 to 0.1 mm. The capped heads have an average diameter (i.e., measured radially of the axis of the capped heads and the stems) to average capped head thickness ratio preferably from 1.5:1 to 12:1, and more preferably from 2.5:1 to 6:1. For most hook-and-loop uses, the hooks should be distributed substantially uniformly over the entire surface area of the hook strip, usually in a square, staggered or hexagonal array. If the hook density is to high relative to the spacing of the loop supporting projections, the two features can interfere with each other and prevent proper engagement of the hooks with the loop material between the projections.

A second method, for forming a hook strip having hooks is disclosed in U.S. Pat. No. 4,894,060. This second method includes first extruding a strip of thermoplastic resin from an extruder through a die having an opening cut, for example, by electron discharge machining, shaped to form the strip with a base and elongate spaced ribs projecting above an upper surface of the base layer that have the cross sectional shape of the hook portions or members to be formed. The strip is pulled around rollers through a quench tank filled with a cooling liquid (e.g., water), after which the ribs (but not the base layer) are transversely slit or cut at spaced locations along their lengths by a cutter to form discrete portions of the ribs having lengths corresponding to about the desired thicknesses of the hook portions to be formed. Optionally, the strip can be stretched prior to cutting to provide further molecular orientation to the polymers forming the ribs and/or reduce the size of the ribs and the resulting hook members formed by slitting of the ribs. The cutter can cut using any conventional means such as reciprocating or rotating blades, lasers, or water jets, however preferably the cutter cuts using blades oriented at an angle of about 60 to 80 degrees with respect to length of the ribs. After cutting of the ribs, the base of the strip is longitudinally stretched at a stretch ratio of at least 2 to 1, and preferably at a stretch ratio of about 4 to 1, preferably between two pairs of nip rollers driven at different surface speeds. Optionally, the strip can also be transversely stretched to provide biaxial orientation to the base. Stretching causes spaces between the cut portions of the ribs, which then become the hook portions or members for the completed hook fastener.

The size of the heads of the hooks, as noted above, determines the open space required between the fibers of the loop web. Some non-limiting examples of sizes of hook that are useful with the loop laminates of the present invention are microhooks having a height of less than 1000 μm, preferably from 300 to 800 μm. The other dimensions for a microhook includes hook head width 45 of from 100 to 800 μm, and an hook head height or droop 48 of from 50 to 700 μm, preferably 50 to 500 μm, and a hook density of 20-1600 and preferably from about 40 to 150, hooks per square centimeter.

In certain applications very low hook densities are desirable. For example, hook densities of less than 100, preferably less than 70 and even less than 50 hook per square centimeter are desirable when used to attach to low loft nonwovens using a relatively large area flexible hook tab or patch. This low spacing has been found to increase the hooking efficiency of the individual hook element, particularly relative to low cost and otherwise ineffective nonwoven materials not traditionally used as loop products. The hook tab or patch can be made flexible by suitable selection of the polymer forming the base layer and/or by stretching the base layer at an angle transverse to the longitudinal stretching. The fastening tab could be of a size of from 5 to 100 cm², preferably 20 to 70 cm²

Test Methods

135 Degree Twist Peel Test

A 135 degree twist peel test was used to measure the amount of force that was required to peel a mechanical fastener hook material from a sample of the nonwoven loop laminate material. The hook material was made as described in pending U.S. patent application US2003/0182776 Example 8. A 1.9 cm×2.5 cm strip of the hook material was cut with the long dimension being in the machine direction of the web. A 2.5 cm wide paper leader was attached to the smooth side of one end of the hook strip. A 5.1 cm×12.7 cm piece of the loop material of the invention was securely placed on a 5.1 cm×12.7 cm steel panel by using a double-coated adhesive tape. The loop material was placed onto the panel with the ridges of the structured backing being parallel to the short dimension of the panel. The hook material was fastened to the loop material using the following procedure: The hook material, with hook side down, was placed onto the loop material. An aluminum bar measuring 2 cm×3.5 cm×10 cm with medium grit abrasive paper on its bottom surface, was placed on top of the hook material. To engage the hook with the loop material, the bar was pressed firmly downward in a twisting motion 90 degrees to the left, then 90 degrees right and then 45 degrees left. The bar was then removed and the hook/loop assembly was held firm against the surface of a 135 degree jig stand mounted into the lower jaw of an Instron™ Model 1122 tensile tester. The loose end of the paper leader attached to the hook material was placed in the upper jaw of the tensile tester. A crosshead speed of 30.5 cm per minute was used. The peel force was recorded as the hook strip was peeled from the loop material at a constant angle of 135 degrees. An average of the four highest force peaks was recorded in grams and was reported in grams/2.54 cm-width. 10 replicates were tested and averaged and are reported in Table 1.

135 Degree Peel Test

The 135 degree peel test was used to measure the amount of force that was required to peel a sample of mechanical fastener hook material from a sample of nonwoven loop laminate material. The hook material was made as described in pending U.S. patent application US2003/0182776 Example 8. A 5.1 cm×12.7 cm piece of loop test material was securely placed on a 5.1 cm×12.7 cm steel panel by using a double-coated adhesive tape. The loop material was placed onto the panel with the ridges of the structured backing being parallel to the short dimension of the panel. A 1.9 cm×2.5 cm strip of the mechanical fastener material was cut with the long dimension being in the machine direction of the web. A 2.5 cm wide paper leader was attached to the smooth side of one end of the hook strip. The hook strip was then centrally placed onto the loop so that there was a 1.9 cm×2.5 cm contact area between the strip and the loop material and the leading edge of the strip was along the length of the panel. The strip and loop material assembly was then rolled by hand, twice in each direction, using a 1000 gram roller at a rate of approximately 30.5 cm per minute. The sample was then placed in a 135 degree peel jig. The jig was placed into the bottom jaw of an Instron™ Model 1122 tensile tester. The loose end of the paper leader was placed in the upper jaw of the tensile tester. A crosshead speed of 30.5 cm per minute was used. The peel force was recorded as the hook strip was peeled from the loop material at a constant angle of 135 degrees. An average of the four highest peaks was recorded in grams. The force required to remove the mechanical fastener strip from the loop material was reported in grams/2.54 cm-width. 12 replicates were tested and averaged and are reported in Table 1 below.

Dynamic Shear

The dynamic shear test was used to measure the amount of force required to shear a sample of mechanical fastener hook material from a sample of nonwoven loop laminate material. The hook material was made as described in pending U.S. patent application US2003/0182776 Example 8. A 2.5 cm×7.5 cm loop sample was cut and then reinforced with 3M strapping tape on the backside of the loop material. A 1.25 cm×2.5 cm sample of hook material was also prepared. The long dimension is the machine direction of the hook material. This sample was laminated to the end of a tab of 3M strapping tape 2.5 cm wide×7.5 cm long. The strapping tape was doubled over on itself on the end without hook material to cover the adhesive. The hook material was then placed centrally onto the loop material. The hook/loop assembly was then rolled down by hand with a 5 kg roller 5 times up and back. The assembled tabs were placed into the jaws of an Instron™ Model 1122 tensile tester. The hook material tab was placed in the top jaw and the loop material tab was placed in the bottom jaw. A crosshead speed of 30.5 cm per minute was used. The shear force was recorded as the hook strip was sheared from the loop material at a constant angle of 180 degrees. The maximum load was recorded in grams. The force required to shear the mechanical fastener strip from the loop material was reported in grams/2.54 cm-width. Eight (8) replicates were tested and averaged and are reported in Table 1 below.

### EXAMPLES 1-3

A nonwoven loop laminate was made using apparatus similar to that shown in FIG. 1a except three extruders were used to produce a structured backing layer. For convenience due to equipment availability and setup, three extruders were used. One extruder can be used to produce a monolayer backing. The three layers acted as one layer because they are all of the same material. The layers were produced with a polypropylene/polyethylene impact copolymer (7523, 4.0 MFI, Basell Polyolefins Company, Hoofddorp, Netherlands). A 6.35 cm single screw extruder (10 RPM) was used to supply 7523 copolymer for the first ‘A’ layer, a 3.81 cm single screw extruder (8 RPM) was used to supply 7523 copolymer for the second ‘B’ layer and a 2.54 cm single screw extruder (22 RPM) was used to supply 7523 copolymer for the third ‘C’ layer. The barrel temperature profiles of all three extruders were approximately the same from a feed zone of 215° C. gradually increasing to 238° C. at the end of the barrels. The melt streams of the three extruders were fed to a ABC three layer coextrusion feedblock (Cloeren Co., Orange, Tex.). The feedblock was mounted onto a 20 cm die equipped with a profiled die lip similar to that shown in FIG. 1c. The feedblock and die were maintained at 238° C. The die lip was machined with a wire EDM process to produce 3 different zones of vertical openings all connected to a common horizontal opening. The spacing between the vertical openings was 2.5 mm in the first zone, 5.0 mm in the second zone and 7.5 mm in the third zone. The height of the openings was 0.5 μm and the width was 0.25 μm. The die lip gap was adjusted to achieve a desired ridge height in the extrudate. After being shaped by the die lip, the structured ridge side of the extrudate was extrusion laminated to a polypropylene spunbond nonwoven (RFX 17 g/m², Amoco Fabrics and Fibers, Austell, Ga.) at a speed of 2.5 meter/min against a water chilled roll which was partially submerged in a water bath maintained at approximately 20° C. The web was air dried and collected into a roll. The resulting web had a relatively flat nonwoven layer securely bonded to the ridges of the backing similar to that shown in FIG. 2a. The height and spacing of the ridges for the three zones of the web are reported in Table 1 below.

### EXAMPLES 4-6

A nonwoven loop laminate was prepared as in Examples 1-3 above except the die lip gap was adjusted to increase the ridge height. The height and spacing of the ridges for the three zones of the web are reported in Table 1 below.

### EXAMPLES 7-9

A nonwoven loop laminate was prepared as in Examples 1-3 above except the die lip gap was adjusted to increase the ridge height. The height and spacing of the ridges for the three zones of the web are reported in Table 1 below.

### EXAMPLES 10-12

A nonwoven loop laminate was prepared as in Examples 1-3 above except a different polypropylene spunbond nonwoven was used (Celestra 17 g/m², BBA Nonwovens, Simpsonville, S.C.). The die lip gap was adjusted to increase the ridge height. The height and spacing of the ridges for the three zones of the web are reported in Table 1 below. Peel and shear properties were not measured for examples 11 and 12.

### COMPARATIVE EXAMPLE C1

A comparative example was prepared with a nonwoven loop material laminated to a non-structured flat film. The RFX nonwoven described above was heat sealed to a 50 micron thick cast polypropylene/polyethylene copolymer film using a Sentinel Heat Sealer. The heat sealer apparatus consisted of a smooth metal lower platen and an upper heated aluminum platen (260° C. set point) having elevated ridges spaced 4.75 mm apart. A 5 cm×10 cm piece of the RFX nonwoven was placed onto the lower platen and then a 5 cm×10 cm piece of the film was placed onto the nonwoven. A 5 cm×10 cm piece of standard 9 kg weight copying paper was placed on top of the film to provide some thermal protection to the film. The two platens were brought together for a seal time of 3 seconds. The resulting laminate was sealed via continuous lines provided by the ridges in the heated platen at a spacing of 4.75 mm. These continuous bond lines were analogous to the ridge lines in examples 1-12, except they had a height of zero. The regions in between the seal lines were not bonded and consisted of the nonwoven laying relatively flat against the film providing insufficient areas for a hook material to penetrate.

### COMPARATIVE EXAMPLE C2

A comparative example was prepared as in comparative example C1 except a different polypropylene spunbond nonwoven was used (Celestra, 17 g/m², BBA Nonwovens, Simpsonville, S.C.).

TABLE 1

| | Ridge | Ridge | 135 Twist | 135 Peel | Dynamic |
|---|---|---|---|---|---|
| Ex- | height | spacing | Peel Strength | Strength | Shear |
| ample | (microns) | (mm) | (g/2.54 cm) | (g/2.54 cm) | (g/2.54 cm) |
| C1 | 0* | 4.75* | 84 | 22 | 49 |
| C2 | 0* | 4.75* | | 57 | 142 |
| 1 | 127 | 2.54 | 126 | | |
| 2 | 127 | 5.08 | 97 | | |
| 3 | 127 | 7.62 | 105 | | |
| 4 | 279 | 2.54 | 146 | | |
| 5 | 279 | 5.08 | 137 | | |
| 6 | 279 | 7.62 | 149 | | |
| 7 | 432 | 2.54 | 209 | 90 | 250 |
| 8 | 432 | 5.08 | 211 | | |
| 9 | 432 | 7.62 | 205 | | |
| 10 | 432 | 2.54 | | 128 | 580 |
| 11 | 432 | 5.08 | | | |
| 12 | 432 | 7.62 | | | |

*C1 & C2 did not have raised ridges to elevate the loop material. The value shown for ridge spacing is the distance between bond lines used to bond the nonwoven to the film backing

We claim:

1. A loop laminate for use in a hook and loop fastening system comprising; a backing layer, having a first face and a second face,
a plurality of projections extending from at least the first face of the backing layer wherein some of the projections have a height (h) of at least 50 μm and;
a loop material attached to at least some of the projections such that said loop material is raised off the backing layer over at least some portion of the distance between the adjacent attached projections.

2. The loop laminate of claim 1 wherein the loop material is raised off the backing layer for more than 10 percent of the distance between at least some of the adjacent projections to which the loop material is attached.

3. The loop laminate of claim 1 wherein the projections are integrally formed with the backing layer.

4. The loop laminate of claim 3 wherein the projections are generally from 50 to 1000 μm in height (h).

5. The loop laminate of claim 3 wherein the projections are generally from 100 to 500 μm in height (h).

6. The loop laminate of claim 4 wherein the projections are generally all of equal height.

7. The loop laminate of claim 4 wherein the projections have different heights and at least a portion of the projections are in the range from 50 to 1000 μm in height.

8. The loop laminate of claim 4 wherein at least 2 percent up to 30 percent of the area of the backing is occupied by the peaks of the projections to which the loop material is attached.

9. The loop laminate of claim 8 wherein at most 10 percent of the area of the backing is occupied by the peaks of the projections to which the loop material is attached.

10. The loop laminate of claim 3 wherein the projections have a width from 50 to 1000 μm.

11. The loop laminate of claim 3 wherein the projections have a width of from 100 to 500 μm.

12. The loop laminate of claim 3 wherein the projections are discrete posts.

13. The loop laminate of claim 3 wherein the projections are ridges.

14. The loop laminate of claim 13 wherein the ridges extend continuously over at least one dimension of the loop laminate.

15. The loop laminate of claim 1 wherein loop material is raised off the backing by at least 10 percent of the distance on average between adjacent supporting projections.

16. The loop laminate of claim 1 wherein the loop material is raised off the backing over at least 30 percent of the distance on average between the adjacent attached projections.

17. The loop laminate of claim 1 wherein the loop material is raised off the backing over at least 50 percent of the distance on average between the adjacent attached projections.

18. The loop laminate of claim 1 wherein the loop material is a knitted or woven material capable of engaging with a hook strip.

19. The loop laminate of claim 3 wherein the loop material is a nonwoven web of entangled fibers.

20. The loop laminate of claim 19 wherein the nonwoven material has a basis weight of from 10 to 100 g/m².

21. The loop laminate of claim 3 wherein the nonwoven material has a basis weight of from 10 to 50 g/m².

22. The loop laminate of claim 3 wherein the backing layer is a continuous thermoplastic film layer.

23. The loop laminate of claim 22 wherein the backing layer and the loop material are thermally bonded at the peaks of the projections.

24. The loop laminate of claim 22 wherein the backing layer and the loop material are adhesively bonded at the peaks of the projections.

25. The loop laminate of claim 22 wherein the backing layer and the loop material are mechanically bonded at the peaks of the projections.

26. The loop laminate of claim 1 wherein the backing has a basis weight of from 15 to 150 g/m².

27. The loop laminate of claim 1 wherein the backing has a basis weight of from 20 to 50 g/m².

28. The loop laminate of claim 26 wherein the loop laminate has a basis weight of from 30 to 300 g/m².

29. The loop laminate of claim 26 wherein the loop laminate has a basis weight of from 40 to 100 g/m².

30. A hook and loop fastening system comprising a loop laminate having a backing layer having a first face and a second face, a plurality of projections extending from at least the first face of the backing layer wherein some of the projections have a height (h) of at least 50 μm and a loop material attached to at least some of the projections such that said loop material is raised off the backing layer over at least some portion of the distance between adjacent projections and a mating hook material formed of hooks on a backing, the hooks having hook heads capable of engaging the loop material in the regions between the attached projections.

31. A hook and loop fastening system of claim 30 where the hook head height is less than the height of the projections and the overlying loop material.

32. A hook and loop fastening system of claim 30 where the hook head height is less than the height of the projections to which the loop material is attached.

33. A hook and loop fastening system of claim 32 where the hook head height is less than the height of the projections to which the loop material is attached by at least 10 percent.

34. A hook and loop fastening system of claim 32 where the hook head height is less than the height of the projections to which the loop material is attached by at least 50 percent.

35. A hook and loop fastening system of claim 32 where the hook head width is less than the spacing between adjacent projections.

36. A hook and loop fastening system of claim 32 where the hook head width is at least 30 less than the spacing between adjacent projections.

37. A hook and loop fastening system of claim 32 where the hook head width is at least 50 percent less than the spacing between adjacent projections.

38. A hook and loop fastening system of claim 32 where the hook head width is on average a whole number multiple of the spacing between adjacent projections, plus or minus 5 percent.

39. A hook and loop fastening system of claim 30 where the hook head is engaged with the loop, less than 30 percent of the hook heads contact a projection, when the hook material is engaged with the loop laminate in the least interfering manner.

40. A hook and loop fastening system of claim 30 wherein when the hook head is engaged with the loop less than 10 percent of the hook heads contact a projection, when the hook material is engaged with the loop laminate in the least interfering manner.

41. The hook and loop fastening system of claim 30 wherein the loop material is raised off the backing layer for more than 10 percent of the distance between at least some of the adjacent projections to which the loop material is attached.

42. The hook and loop fastening system of claim 30 wherein the projections are integrally formed with the backing layer.

43. The hook and loop fastening system of claim 30 wherein the projections are generally from to 50 to 1000 μm in height (h).

44. The hook and loop fastening system of claim 43 wherein the projections are generally from 100 to 500 μm in height (h).

45. The hook and loop fastening system of claim 30 wherein at least 2 percent up to 30 percent of the backing is occupied by the peaks of the projections to which the loop material is attached.

46. The hook and loop fastening system of claim 30 wherein the projections are discrete posts.

47. The hook and loop fastening system of claim 30 wherein the projections are ridges.

48. The hook and loop fastening system of claim 30 where the loop material is raised off the backing over at least 10 percent of the distance on average between the adjacent attached projections.

49. The hook and loop fastening system of claim 30 where the loop material is raised off the backing over at least 30 percent of the distance on average between the adjacent supporting projections

50. The hook and loop fastening system of claim 30 where the loop material is raised off the backing over at least 50 percent of the distance on average between the adjacent attached projections.

51. The hook and loop fastening system of claim 30 wherein the loop material is a nonwoven web of entangled fibers.

52. The hook and loop fastening system of claim 51 wherein the nonwoven material has a basis weight of from 10 to 100 g/m².

53. The hook and loop fastening system of claim 30 wherein the nonwoven loop material has a basis weight of from 10 to 50 g/m².

54. The hook and loop fastening system of claim 30 wherein the backing layer is a continuous thermoplastic film layer.

55. The hook and loop fastening system of claim 30 wherein the backing has a basis weight of from 15 to 150 g/m².

56. The hook and loop fastening system of claim 30 wherein the backing has a basis weight of from 20 to 50 g/m².

57. The hook and loop fastening system of claim 56 wherein the loop laminate has a basis weight of from 30 to 300 g/m².

58. The hook and loop fastening system of claim 56 wherein the loop laminate has a basis weight of from 40 to 100 g/m².
